(19) United States
(12) Patent Application Publication
(10) Pub. No.: US 2014/0214826 A1
(43) Pub. Date: Jul. 31, 2014

(54) RANKING METHOD AND SYSTEM

(71) Applicant: TENCENT TECHNOLOGY (SHENZHEN) COMPANY LIMITED, Shenzhen (CN)

(72) Inventor: YASHENG ZHANG, Shenzhen (CN)

(73) Assignee: TENCENT TECHNOLOGY (SHENZHEN) COMPANY LIMITED, Shenzhen (CN)

(21) Appl. No.: 14/230,096

(22) Filed: Mar. 31, 2014

Related U.S. Application Data
(63) Continuation of application No. PCT/CN2013/087261, filed on Nov. 15, 2013.

(30) Foreign Application Priority Data
Jan. 29, 2013 (CN) 2013100341800

(51) Int. Cl. G06F 17/30

(52) U.S. Cl. CPC G06F 17/3053
USPC 707/732

(57) ABSTRACT

Various embodiments provide ranking methods and systems. The ranking method can be implemented by a computer system. In an exemplary method, real-time data can be obtained. A total user number of the real-time data can be counted. A distribution pattern of user number in one or more data value intervals can be obtained from the real-time data. The total user number and the distribution pattern can then be stored as intermediate data. A ranking query request of a user and an actual data value of the user can be received. A ranking of the user can be calculated according to the actual data value of the user and the intermediate data.

### CROSS-REFERENCES TO RELATED APPLICATIONS

This application is a continuation application of PCT Patent Application No. PCT/CN2013/087261, filed on Nov. 15, 2013, which claims priority to Chinese Patent Application No. 201310034180.0, filed on Jan. 29, 2013, the entire contents of all of which are incorporated herein by reference.

### FIELD OF THE DISCLOSURE

The present disclosure generally relates to computer technology and, more particularly, relates to ranking methods and systems.

### BACKGROUND

With development of network technology, the Internet has become an important part in people's working and learning. In Internet applications, user data often need to be ranked. In a conventional method, all user attribute values that need to be ranked (for example, member growth value, game player experience value, etc.) are extracted, i.e., the full amount of user attribute values are extracted, and ranking calculation is performed using a significant amount of machine resources. At last, each user's ranking, after the ranking calculation, is stored in order to be pulled and displayed when needed.

The conventional ranking method has some disadvantages. For example, the ranking calculation needs to be performed based on all the user data, and thus requires a large amount of computation. Ranking of vast user data consumes a large amount of computer resources and has a prohibitive cost. Further, after the calculation, ranking results contain all the user data. Storing the ranking results of all the user data consumes a large amount of storage space.

In addition, in the conventional method, the ranking calculation is performed using all the user data, which requires a large amount of computation and a long calculation time. Thus, it is difficult to collect the user data in real time within a short period of time. Therefore, the calculation is an analysis and computation based on offline data, and ranking data cannot be updated in real time.

### BRIEF SUMMARY OF THE DISCLOSURE

One aspect of the present disclosure includes a ranking method. The ranking method can be implemented by a computer system. In an exemplary method, real-time data can be obtained. A total user number of the real-time data can be counted. A distribution pattern of user number in one or more data value intervals can be obtained from the real-time data. The total user number and the distribution pattern can then be stored as intermediate data. A ranking query request of a user and an actual data value of the user can be received. A ranking of the user can be calculated according to the actual data value of the user and the intermediate data.

Another aspect of the present disclosure includes a ranking system. An exemplary system can include a data-obtaining module, a statistics module, a distribution-pattern-obtaining module, a storage module, an interaction module, and a calculation module. The data-obtaining module can be configured to obtain real-time data. The statistics module can be configured to count a total user number of the real-time data. The distribution-pattern-obtaining module can be configured to obtain a distribution pattern of user number of the real-time data in one or more data value intervals. The storage module can be configured to store intermediate data, wherein the intermediate data includes the total user number and the distribution pattern. The interaction module can be configured to communicate with user terminals. The calculation module can be configured to calculate a ranking of a user according to an actual data value of the user and the intermediate data.

Another aspect of the present disclosure includes a non-transitory computer-readable medium having computer program. When being executed by a processor, the computer program performs a method for performing a ranking method. The method includes obtaining real-time data, counting a total user number of the real-time data, and obtaining from the real-time data a distribution pattern of user number in one or more data value intervals. The method also includes storing the total user number and the distribution pattern as intermediate data, receiving a ranking query request of a user and an actual data value of the user, and calculating a ranking of the user according to the actual data value of the user and the intermediate data.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1 depicts a flow diagram of an exemplary ranking method in accordance with various disclosed embodiments;

FIG. 2 depicts a structure diagram of an exemplary ranking system in accordance with various disclosed embodiments;

FIG. 3 depicts a structure diagram of an exemplary distribution-pattern-obtaining module in accordance with various disclosed embodiments;

FIG. 4 depicts a structure diagram of another exemplary distribution-pattern-obtaining module in accordance with various disclosed embodiments;

FIG. 5 depicts an exemplary environment incorporating certain disclosed embodiments; and

FIG. 6 depicts an exemplary computing system consistent with the disclosed embodiments.

### DETAILED DESCRIPTION

Reference will now be made in detail to exemplary embodiments of the disclosure, which are illustrated in the accompanying drawings.

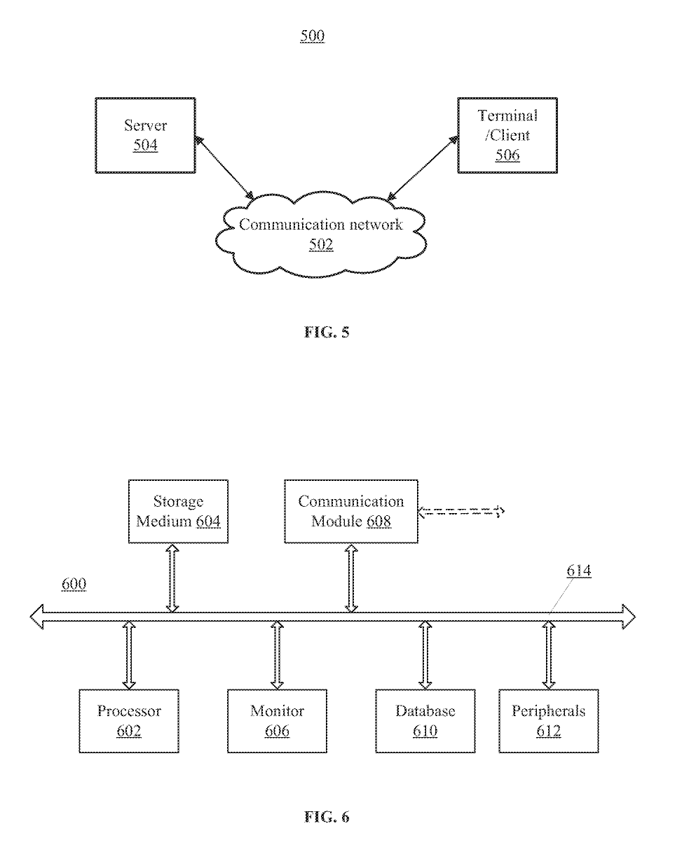

Various embodiments provide ranking methods and systems. FIG. 5 depicts an exemplary environment 500 incorporating exemplary ranking methods and systems in accordance with various disclosed embodiments. As shown in FIG. 5, the environment 500 can include a server 504, a terminal 506, and a communication network 502. The server 504 and the terminal 506 may be coupled through the communication network 502 for information exchange, such as collecting user data, sending/receiving ranking query request, sending/receiving ranking calculation results, etc. Although only one terminal 506 and one server 504 are shown in the environment 500, any number of terminals 506 or servers 504 may be included, and other devices may also be included.

The communication network 502 may include any appropriate type of communication network for providing network connections to the server 504 and terminal 506 or among multiple servers 504 or terminals 506. For example, the communication network 502 may include the Internet or other types of computer networks or telecommunication networks, either wired or wireless.

A terminal, as used herein, may refer to any appropriate user terminal with certain computing capabilities, e.g., a personal computer (PC), a work station computer, a hand-held computing device (e.g., a tablet), a mobile terminal (e.g., a mobile phone or a smart phone), or any other client-side computing device.

A server, as used herein, may refer to one or more server computers configured to provide certain server functionalities, e.g., real-time data collecting, and data calculation. A server may also include one or more processors to execute computer programs in parallel.

The server 504 and the terminal 506 may be implemented on any appropriate computing platform. FIG. 6 shows a block diagram of an exemplary computing system 600 capable of implementing the server 504 and/or the terminal 506. As shown in FIG. 6, the exemplary computer system 600 may include a processor 602, a storage medium 604, a monitor 606, a communication module 608, a database 610, peripherals 612, and one or more bus 614 to couple the devices together. Certain devices may be omitted and other devices may be included.

The processor 602 can include any appropriate processor or processors. Further, the processor 602 can include multiple cores for multi-thread or parallel processing. The storage medium 604 may include memory modules, e.g., Read-Only Memory (ROM), Random Access Memory (RAM), and flash memory modules, and mass storages, e.g., CD-ROM, U-disk, removable hard disk, etc. The storage medium 604 may store computer programs for implementing various processes (e.g., obtaining real-time data, data calculations, etc.), when executed by the processor 602.

The monitor 606 may include display devices for displaying contents in the computing system 600, e.g., displaying ranking information or game interface. The peripherals 612 may include I/O devices such as keyboard and mouse.

Further, the communication module 608 may include network devices for establishing connections through the communication network 502. The database 610 may include one or more databases for storing certain data and for performing certain operations on the stored data, e.g., storing intermediate data for ranking calculation, storing real-time data, storing mathematical calculation programs, etc.

In operation, the terminal 506 may cause the server 504 to perform certain actions, e.g., receiving a ranking query request of a user from a user terminal, or returning ranking of the user. The server 504 may be configured to provide structures and functions for such actions and operations. The terminal 506 may be configured to provide structures and functions correspondingly for suitable actions and operations. More particularly, the server 504 may include a query service for calculating/estimating a user ranking and return the ranking to a user terminal.

In various embodiments, a terminal such as a mobile terminal involved in the disclosed methods and systems can include the terminal 506, while a server involved in the disclosed methods and systems can include the server 504. The methods and systems disclosed in accordance with various embodiments can be executed by a computer system (i.e., a computing system). In one embodiment, the disclosed methods and systems can be implemented by a server.

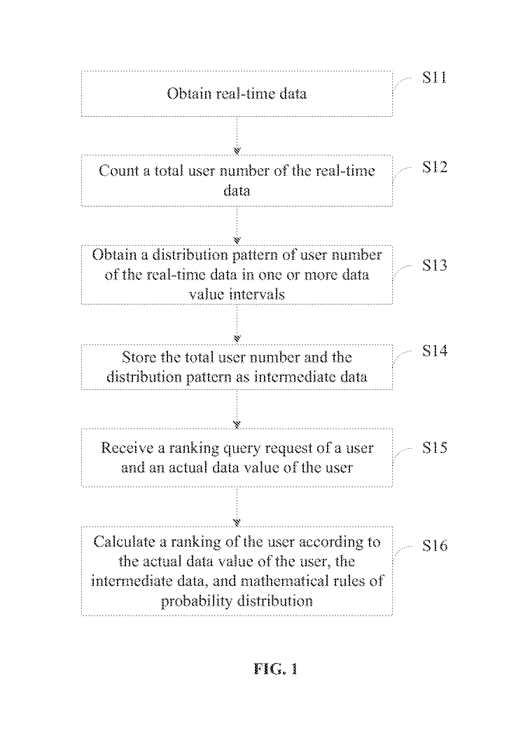

FIG. 1 depicts a flow diagram of an exemplary ranking method in accordance with various disclosed embodiments. The method can include the following exemplary steps.

In Step S11, real-time data are obtained. The real-time data can serve as data basis for ranking calculation. In various embodiments, user data (or data) can refer to various attribute value data of users including, e.g., time, game player experience value, etc. These data can be ranked according to numerical magnitude.

The real-time data can be collected regularly within preset time periods. A shorter time interval of the collection can result in more real-time ranking and higher accuracy. Further, the real-time data can be collected using a sampling method. For example, when a distribution of the user data does not have any certain pattern, the user data may be collected not by a global scanning, but may be collected by sampling a certain percentage of the user data. Thus, computer resources can be further saved. When the real-time data are collected using the sampling method, a ranking of a user needs to be reduced to a ranking among all the user data according to the percentage of the sampling.

In Step S12, a total user number of the real-time data is counted. For example, after obtaining the real-time data as the basis for the ranking calculation, by performing a global scanning of the obtained real-time data, the total user number contained in the real-time data (or the data) can be counted. Generally, one data value can correspond to one user. For example, when ranking online time of the users, the real-time data obtained can include time data. During the scanning of the real-time data, the identifying of one value of time data can make one count, so the total user number can be counted. As used herein, unless otherwise specified, a ‘data value’ can refer to a value contained in the data, and ‘user number’ can refer to ‘number of users’.

In Step S13, a distribution pattern of user number of the real-time data is obtained in one or more data value intervals.

The distribution of certain data values of the users can be regarded mathematically as a probability distribution. When currently all user attribute values have a lower limit of N1, a higher limit of N2, and a user number (i.e., a total user number) of M, the values can be treated as a distribution of M value objects in a (N1, N2) interval. Common distributions can include uniform distribution (i.e., the number of objects at each point from N1 to N2 is equal) and normal distribution (i.e., the number of objects is greater at points that are closer to a midpoint between N1 and N2). As used herein, unless otherwise specified, an ‘object’, a ‘value object’ or a ‘user value object’ can refer to an object having a value or associated with the value, e.g., a user associated with the value.

In this example, the distribution pattern can refer to a distribution situation of the value objects which is obtained according to the user number in a data value interval, assuming the distribution of users in the data value interval is a uniform distribution. Data that can be used to indicate the distribution pattern of the users can include a maximum data value and a minimum data value of a data value interval, the user number of the data value interval, the user number between a minimum data value or a maximum data value (of the real-time data) and each node of the data value interval(s). Various data to indicate the distribution pattern can be obtained according to the needs of the ranking calculation.

In Step S14, the total user number and the distribution pattern are stored as intermediate data.

In Step S15, a ranking query request of a user (or a queried user) and an actual data value of the user are received.

In Step S16, according to the actual data value of the user, the intermediate data, and/or mathematical rules of probability distribution, a ranking of the user is calculated. In various embodiments, mathematical rules of probability distribution can include mathematical formulas, e.g., formula 1, formula 2, and/or other suitable formulas. Methods of ranking calculation can be further detailed in the following examples, where the formula 1 and formula 2 are further detailed.

In one example, the method can include identifying the minimum (or lowest) data value and the maximum (or highest) data value. In this case, the distribution pattern can be the distribution situation of user value objects in the interval between the minimum data value and the maximum data value. The user number in the interval between the minimum data value and the maximum data value can be the total user number of the real-time data. Thus, in this case, the intermediate data can include the minimum data value, the maximum data value and the total user number.

When the ranking query request of the user is received, according to the user's actual data value, the intermediate data, and/or the mathematical rules of probability distribution, an approximate ranking can be calculated directly. For example, assuming a uniform distribution, according to the probability distribution, a ratio of the user number between the maximum data value and the actual data value to the total user number can be equal to a ratio of a difference between the maximum data value and the actual data value to a difference between the maximum data value and the minimum value. Thus, the user number between the maximum data value and the actual data value can be calculated, which can be the user number ranked before (i.e., higher than) the queried user. For example, a calculation formula can be:

P=(m(n2−n)/(n2−n1))+1 (Formula 1)

P can be the ranking of the queried user, m can be the total user number of the real-time data, n1 can be the minimum data value of the real-time data, n2 can be the maximum data value of the real-time data, and n can be the actual data value of the queried user.

In the above-depicted example, calculation results may have some deviation from actual results, because the actual distribution of the users may not be exactly uniform as previously assumed. Thus, various disclosed embodiments provide another method, such that accuracy of calculation can be improved by increasing a number of the distribution intervals. In this case, a distribution pattern can refer to a distribution situation of user value objects in a plurality of attribute value intervals. Unless otherwise specified, ‘attribute value’ can also be referred to as ‘data value’, and ‘attribute value intervals’ can also be referred to as ‘data value intervals’.

First, the minimum data value and the maximum data value in the real-time data are identified. Next, the data values (i.e., the real-time data) between the minimum data value and the maximum data value are sequentially split into a plurality of attribute value intervals. The more the attribute value intervals, the greater the accuracy of the calculated ranking.

For each attribute value interval, a relative minimum data value and a relative maximum data value are then obtained. The relative minimum data value and the relative maximum data value of the attribute value interval can refer to a minimum data value and a maximum data value of the attribute value interval, respectively.

Further, the user number between the minimum data value of the real-time data and the relative maximum data value of each attribute value interval (i.e., the user number between the minimum data value and the nodes of each attribute value interval) is obtained. Thus, in this case, the intermediate data can include the minimum data value and the maximum data value of the real-time data, the total user number of the real-time data, the number of attribute value intervals, the relative minimum data value and the relative maximum data value of each attribute value interval, and the user number that falls in each attribute value interval.

When the ranking query request of the user is received, according to the actual data value of the user, the intermediate data, and/or the mathematical rules of probability distribution, an approximate ranking can be calculated directly. For example, a calculation formula can be:

P=(m−iy+(ky−n)(iy−ix)/(ky−kx))+1. (Formula 2)

P can be the ranking of the queried user, m can be the total user number of the real-time data, ix can be the user number that falls between the minimum data value of the real-time data and the relative minimum data value of the attribute value interval that the queried user belongs to, iy can be the user number that falls between the minimum data value and the relative maximum data value of the attribute value interval that the queried user belongs to, kx can be the relative minimum data value of the attribute value interval that the queried user belongs to, ky can be the relative maximum data value of the attribute value interval that the queried user belongs to, and n can be the actual data value of the queried user.

For example, the interval of the real-time data between the minimum data value and the maximum data value (n1, n2) can be evenly split into about 10 attribute value intervals (n1, k1, k2 . . . k9, n2). Next, a scanning can be performed on the real-time data to count the number i of users falling between n1 and each node. For example, i1 can indicate the user number having attribute values between n1 and k1 . . . ; i3 can indicate the user number having attribute values between n1 and k3 . . . ; and i9 can indicate the user number having attribute values between n1 and k9. Assuming n is between the k4 and k5, and the users in each attribute value interval are uniformly distributed, the ranking P of a user having an attribute value of n can be calculated as

P=(m−i5+(k5−n)(i5−i4)/(k5−k4))+1.

In the example depicted above, the interval (n1, n2) can be split into about 10 segments. However, in practical applications, depending on specific situation, the interval can be split into any desired number of segments. More segments can lead to a calculated ranking that is closer to the actual ranking, although corresponding amount of computation and consumed storage space can be greater. In addition, each segment does not need to be of equal length. The length of each segment can be determined according to prior analysis. For example, where data are sparsely distributed, the segment can be longer. Where data are densely distributed, the segment can be shorter. Thus the resultant data can be more accurate.

When the real-time data are collected by sampling, the ranking P of the user needs to be divided by a sampling rate (or sampling percentage) to obtain the user's final ranking over all the user data.

The methods in accordance with various disclosed embodiments can be further illustrated by a specific application as follows. For example, in a game, total game times (or total game time lengths) of all users need to be ranked, such that the user can be informed of a current term (or current name, or current noun) corresponding to his/her game time at his/her request. Assuming that the game has a total of about 64 databases, the method can be implemented as follows.

In Step 1, one database is randomly extracted from the about 64 distributed databases as a sample (or a sample database). In Step 2, a shortest game time and a longest game time are extracted, and a segmentation method is designed (e.g., dividing into about 100 segments).

In Step 3, in the sample database, the user number falling within each segment is calculated. Further, according to mathematical rules of probability, the user number falling within each segment is calculated for the circumstance including all the users (e.g., in this case, in each segment, a ratio of the user number from the sample database to the user number from all the databases can be about 1/64).

In Step 4, pre-processing results (e.g., obtained from Steps 1-3) are stored into a configuration file for a query service to read. In Step 5, when the ranking of the user needs to be displayed, a request for a query service can be initiated with a current game time of the user provided. Thus, based on the pre-processing results and the current game time of the user, the query service can approximately estimate and return the ranking of the user among all the users.

The methods for obtaining user ranking according to various disclose embodiments have various advantages. For example, the amount of computation can be reduced. According to the actual data value of the user and the intermediate data, coupled with the mathematical rules of probability distribution, the ranking of the user can be calculated. Based on various accuracy requirements for the ranking, different interval segmentation methods can be designed.

In addition, storage space consumption can be reduced. The rankings of the users do not need to be stored. By storing only the intermediate data, the ranking of the user can be dynamically calculated according to the current data value. Further, the ranking can be performed in real time. After the user's data value increases, the obtained ranking of the user can become higher accordingly.

Still further, the user(s) are not able to disprove the ranking (i.e., not able to prove that his/her ranking is not an actual ranking). The methods of calculation according to various embodiments are consistent with ordering of ranking (i.e., a person having a higher data value can have a higher ranking than a person having a lower data value, and after the data value is upgraded or increased, the ranking can becomes higher accordingly). Generally, the user(s) are not concerned about his/her actual ranking. The core of his/her concern is the ranking in comparison with others' rankings, as well as the upgrading of the ranking after the upgrading of his/her data value. Thus, the ranking of the user obtained by the methods in accordance with various embodiments can have a high authenticity.

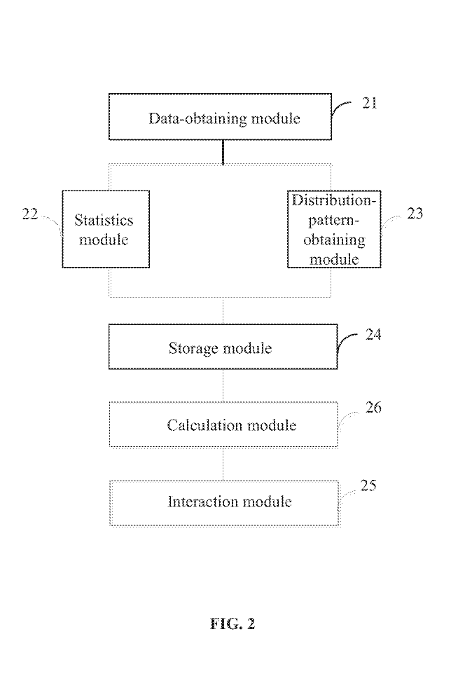

Various embodiments also provide ranking systems. For example, FIG. 2 depicts a structure diagram of an exemplary ranking system in accordance with various disclosed embodiments. The system can include a data-obtaining module 21, a statistics module 22, a distribution-pattern-obtaining module 23, a storage module 24, an interaction module 25, and/or a calculation module 26. Some modules may be omitted and other modules may be included.

The statistics module 22 and the distribution-pattern-obtaining module 23 can be connected to the data-obtaining module 21. The storage module 24 can be respectively connected to the statistics module 22 and the distribution-pattern-obtaining module 23. The calculation module 26 can be connected to the storage module 24. The interaction module 25 can be connected to the calculation module 26.

Before performing ranking calculation, intermediate data need to be obtained. First, the data-obtaining module 21 is configured to obtain real-time data. The real-time data can be obtained by collecting all the user data, or by sampling the user data.

After the real-time data are obtained, the statistics module 22 is configured to count a total user number of the real-time data. The distribution-pattern-obtaining module 23 is configured to obtain a distribution pattern of user number of the real-time data in at least one data value interval. The storage module 24 is configured to store the total user number and the distribution pattern as the intermediate data.

In this example, the distribution pattern can refer to a distribution situation of the value objects which is obtained according to the user number in a data value interval, assuming the distribution of users in the data value interval is a uniform distribution. Data that can be used to indicate the distribution pattern of the users can include a maximum data value and a minimum data value of a data value interval, the user number of the data value interval, the user number between a minimum data value or a maximum data value (of the real-time data) and each node of the data value interval(s). Various data to indicate the distribution pattern can be obtained according to the needs of the ranking calculation.

The interaction module 25 is configured to communicate with user terminals. For example, when the interaction module 25 receives a ranking query request of a user, the calculation module 26 is configured to obtain an actual data value of the user from a database, and obtain the intermediate data from the storage module 24. Next, the calculation module 26 is configured to calculate a ranking of the queried user according to the actual data value of the queried user, the intermediate data, and/or mathematical rules of probability distribution. The interaction module 25 is further configured to return (or feedback) the calculated ranking to the corresponding user terminal.

According to various distribution patterns obtained by the distribution-pattern-obtaining module 23, the calculation module 26 can be configured to calculate user ranking using various formulas, which are further illustrated in the following examples.

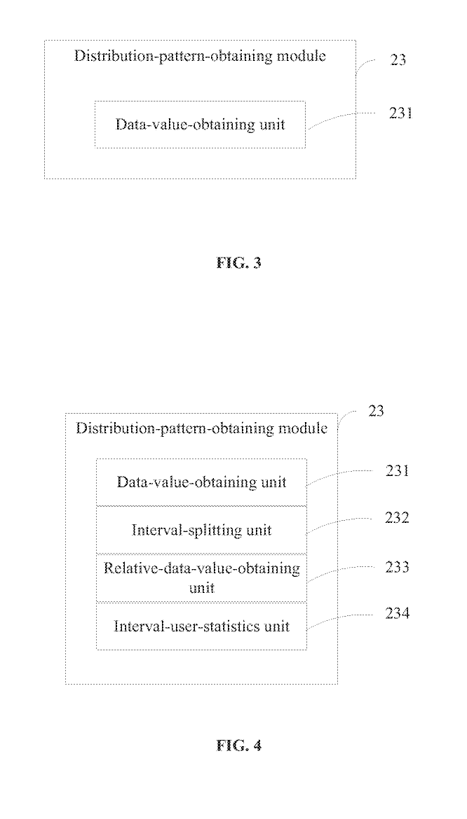

FIG. 3 depicts a structure diagram of an exemplary distribution-pattern-obtaining module in accordance with various disclosed embodiments. In this example, the distribution-pattern-obtaining module 23 can include a data-value-obtaining unit 231. Some units may be omitted and other units may be included.

The data-value-obtaining unit 231 is configured to obtain the minimum data value and the maximum data values of the real-time data. In this case, the distribution pattern obtained by the distribution-pattern-obtaining module 23 can be the distribution situation of user data value objects in the interval between the minimum data value and the maximum data value. The user number in the interval between the minimum data value and the maximum data value can be the total user number of the real-time data. Thus, in this case, the intermediate data can include the minimum data value, the maximum data value and the total user number.

When the ranking query request of the user is received, according to the user's actual data value, the intermediate data, and/or the mathematical rules of probability distribution, the calculation module 26 can directly calculate an approximate ranking. For example, assuming a uniform distribution of users, according to the probability distribution, a ratio of the user number between the maximum data value and the actual data value to the total user number can be equal to a ratio of a difference between the maximum data value and the actual data value to a difference between the maximum data value and the minimum value. Thus, the user number between the maximum data value and the actual data value can be calculated, which can be the user number ranked before (i.e., higher than) the queried user. For example, a calculation formula used by the calculation module 26 can be:

P=(m(n2−n)/(n2−n1))+1. (Formula 1)

P can be the ranking of the queried user, m can be the total user number of the real-time data, n1 can be the minimum data value of the real-time data, n2 can be the maximum data value of the real-time data, and n can be the actual data value of the queried user.

FIG. 4 depicts a structure diagram of another exemplary distribution-pattern-obtaining module in accordance with various disclosed embodiments. In this example, the distribution-pattern-obtaining module 23 can include a data-value-obtaining unit 231, an interval-splitting unit 232, a relative-data-value-obtaining unit 233, and an interval-user-statistics unit 234. Some units may be omitted and other units may be included.

The data-value-obtaining unit 231 is configured to obtain the minimum data value and the maximum data value of the real-time data. The interval-splitting unit 232 is configured to split the data values between the minimum data value and the maximum data value sequentially into a plurality of attribute value intervals. The relative-data-value-obtaining unit 233 is configured to obtain a relative minimum data value and a relative maximum data value of each attribute value interval. The interval-user-statistics unit 234 is configured to obtain the user number between the minimum data value of the real-time data and the relative maximum data value of each attribute value interval. In this case, the intermediate data can include the minimum data value and the maximum data value of the real-time data, the total user number of the real-time data, the number of attribute value intervals, the relative minimum data value and the relative maximum data value of each attribute value interval, and the user number that fall in each attribute value interval.

When the ranking query request of the user is received, the calculation module 26 can be configured to directly calculate an approximate ranking according to the actual data value of the user, the intermediate data, and/or the mathematical rules of probability distribution. For example, a calculation formula can be:

P=(m−iy+(ky−n)(iy−ix)/(ky−kx))+1. (Formula 2)

P can be the ranking of the queried user, m can be the total user number of the real-time data, ix can be the user number that falls between the minimum data value of the real-time data and the relative minimum data value of the attribute value interval that the queried user belongs to, iy can be the user number that falls between the minimum data value and the relative maximum data value of the attribute value interval that the queried user belongs to, kx can be the relative minimum data value of the attribute value interval that the queried user belongs to, ky can be the relative maximum data value of the attribute value interval that the queried user belongs to, and n can be the actual data value of the queried user.

When the real-time data are collected by sampling, the ranking P of the user needs to be divided by a sampling rate (or sampling percentage) to obtain the user's final ranking over all the user data.

In various embodiments, the disclosed methods and systems can be implemented by hardware, and/or by software coupled with appropriate hardware platform (e.g., any universal hardware platforms). For example, one or more or all of the steps in each of the exemplary methods herein can be accomplished using a program/software to instruct related hardware. Such program/software can be stored in a non-transitory computer-readable storage medium including, ROM/RAM, magnetic disk, optical disk, etc. In one embodiment, the program/software can be stored in a nonvolatile computer-readable storage medium (e.g., CD-ROM, U-disk, portable hard drive, solid-state drive, etc.). The related hardware can include a computer device, e.g., a personal computer, a server, a network device, etc.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

The disclosed methods and systems can be used in a variety of Internet applications. By using the disclosed methods and systems, real-time data can be obtained. A total user number of the real-time data can be counted. A distribution pattern of user number in one or more data value intervals can be obtained from the real-time data. The total user number and the distribution pattern can then be stored as intermediate data. A ranking query request of a user and an actual data value of the user can be received. A ranking of the user can be calculated according to the actual data value of the user and the intermediate data.

The disclosed ranking method has various advantages. For example, the amount of computation can be reduced. According to the actual data value of the user and the intermediate data, coupled with mathematical rules of probability distribution, the ranking of the user can be calculated. Based on various accuracy requirements for the ranking, different interval segmentation methods can be designed.

In addition, storage space consumption can be reduced. The rankings of the users do not need to be stored. By storing only the intermediate data, the ranking of the user can be dynamically calculated according to the current data value. Further, the ranking can be performed in real time. After the user's data value increases, the obtained ranking of the user can become higher accordingly.

Still further, the user(s) are not able to disprove the ranking (i.e., not able to prove that his/her ranking is not an actual ranking). The methods of calculation according to various embodiments are consistent with ordering of ranking (i.e., a person having a higher data value can have a higher ranking than a person having a lower data value, and after the data value is upgraded or increased, the ranking can becomes higher accordingly). Generally, the user(s) are not concerned about his/her actual ranking. The core of his/her concern is the ranking in comparison with others' rankings, as well as the upgrading of the ranking after the upgrading of his/her data value. Thus, the ranking of the user obtained by the methods in accordance with various embodiments can have a high authenticity.

What is claimed is:

1. A ranking method, implemented by a computer system, comprising:
obtaining real-time data;
counting a total user number of the real-time data;
obtaining, from the real-time data, a distribution pattern of user number in one or more data value intervals;
storing the total user number and the distribution pattern as intermediate data;
receiving a ranking query request of a user and an actual data value of the user; and
calculating a ranking of the user according to the actual data value of the user and the intermediate data.

2. The method according to claim 1, wherein the real-time data include data obtained by sampling.

3. The method according to claim 1, wherein the obtaining of the distribution pattern of user number in the one or more data value intervals includes:
obtaining a minimum data value and a maximum data value of the real-time data.

4. The method according to claim 3, wherein the calculating of the ranking uses a mathematical rule of probability distribution including a formula:
P=(m(n2−n)/(n2−n1))+1, wherein:
P is the ranking of the user, m is the total user number of the real-time data, n1 is the minimum data value of the real-time data, n2 is the maximum data value of the real-time data, and n is the actual data value of the user.

5. The method according to claim 1, wherein the obtaining of the distribution pattern of user number in the one or more data value intervals includes:
obtaining a minimum data value and a maximum data value of the real-time data;
splitting the real-time data between the minimum data value and the maximum data value sequentially into a plurality of attribute value intervals;
obtaining a relative minimum data value and a relative maximum data value of each of the plurality of attribute value intervals; and
obtaining the user number respectively between the minimum data value of the real-time data and the relative maximum data value of the each of the plurality of attribute value intervals.

6. The method according to claim 5, wherein the calculating of the ranking uses a mathematical rule of probability distribution including a formula:
P=(m−iy+(ky−n)(iy−ix)/(ky−kx))+1, wherein:
P is the ranking of the user, m is the total user number of the real-time data, ix is a user number between the minimum data value of the real-time data and a relative minimum data value of an attribute value interval that the user belongs to, iy is a user number between the minimum data value of the real-time data and a relative maximum data value of the attribute value interval that the user belongs to, kx is the relative minimum data value of the attribute value interval that the user belongs to, ky is the relative maximum data value of the attribute value interval that the user belongs to, and n is the actual data value of the user.

7. A ranking system, comprising:
a data-obtaining module configured to obtain real-time data;
a statistics module configured to count a total user number of the real-time data;
a distribution-pattern-obtaining module configured to obtain a distribution pattern of user number of the real-time data in one or more data value intervals;
a storage module configured to store intermediate data, wherein the intermediate data includes the total user number and the distribution pattern;
an interaction module configured to communicate with user terminals; and
a calculation module configured to calculate a ranking of a user according to an actual data value of the user and the intermediate data.

8. The system according to claim 7, wherein the real-time data are obtained by sampling.

9. The system according to claim 7, wherein the distribution-pattern-obtaining module includes:
a data-value-obtaining unit configured to obtain a minimum data value and a maximum data value of the real-time data.

10. The system according to claim 9, wherein the calculation module is configured to calculate the ranking using a mathematical rule of probability distribution including a formula:
P=(m(n2−n)/(n2−n1))+1, wherein:
P is the ranking of the user, m is the total user number of the real-time data, n1 is the minimum data value of the real-time data, n2 is the maximum data value of the real-time data, and n is the actual data value of the user.

11. The system according to claim 7, wherein the distribution-pattern-obtaining module includes:
a data-value-obtaining unit configured to obtain a minimum data value and a maximum data value of the real-time data;
an interval-splitting unit configured to split the real-time data between the minimum data value and the maximum data value sequentially into a plurality of attribute value intervals;
a relative-data-value-obtaining unit configured to obtain a relative minimum data value and a relative maximum data value of each of the plurality of attribute value intervals; and
an interval-user-statistics unit configured to obtain the user number respectively between the minimum data value of the real-time data and the relative maximum data value of the each of the plurality of attribute value intervals.

12. The system according to claim 11, wherein the calculation module is configured to calculate the ranking using a mathematical rule of probability distribution including a formula:
P=(m−iy+(ky−n)(iy−ix)/(ky−kx))+1, wherein:
P is the ranking of the user, m is the total user number of the real-time data, ix is a user number between the minimum data value of the real-time data and a relative minimum data value of an attribute value interval that the user belongs to, iy is a user number between the minimum data value of the real-time data and a relative maximum data value of the attribute value interval that the user belongs to, kx is the relative minimum data value of the attribute value interval that the user belongs to, ky is the relative maximum data value of the attribute value interval that the user belongs to, and n is the actual data value of the user.

13. A non-transitory computer-readable medium having computer program for, when being executed by a processor, performing a ranking method comprising:
obtaining real-time data;
counting a total user number of the real-time data;
obtaining, from the real-time data, a distribution pattern of user number in one or more data value intervals;
storing the total user number and the distribution pattern as intermediate data;
receiving a ranking query request of a user and an actual data value of the user; and
calculating a ranking of the user according to the actual data value of the user and the intermediate data.

14. The non-transitory computer-readable medium according to claim 13, wherein the real-time data include data obtained by sampling.

15. The non-transitory computer-readable medium according to claim 13, wherein the obtaining of the distribution pattern of user number in the one or more data value intervals includes:
obtaining a minimum data value and a maximum data value of the real-time data.

16. The method according to claim 15, wherein the calculating of the ranking uses a mathematical rule of probability distribution including a formula:
P=(m(n2−n)/(n2−n1))+1, wherein:
P is the ranking of the user, m is the total user number of the real-time data, n1 is the minimum data value of the real-time data, n2 is the maximum data value of the real-time data, and n is the actual data value of the user.

17. The non-transitory computer-readable medium according to claim 13, wherein the obtaining of the distribution pattern of user number in the one or more data value intervals includes:
obtaining a minimum data value and a maximum data value of the real-time data;
splitting the real-time data between the minimum data value and the maximum data value sequentially into a plurality of attribute value intervals;
obtaining a relative minimum data value and a relative maximum data value of each of the plurality of attribute value intervals; and
obtaining the user number respectively between the minimum data value of the real-time data and the relative maximum data value of the each of the plurality of attribute value intervals.

18. The non-transitory computer-readable medium according to claim 17, wherein the calculating of the ranking uses a mathematical rule of probability distribution including a formula:
P=(m−iy+(ky−n)(iy−ix)/(ky−kx))+1, wherein:
P is the ranking of the user, m is the total user number of the real-time data, ix is a user number between the minimum data value of the real-time data and a relative minimum data value of an attribute value interval that the user belongs to, iy is a user number between the minimum data value of the real-time data and a relative maximum data value of the attribute value interval that the user belongs to, kx is the relative minimum data value of the attribute value interval that the user belongs to, ky is the relative maximum data value of the attribute value interval that the user belongs to, and n is the actual data value of the user.
